(19) United States
(12) Patent Application Publication
(10) Pub. No.: US 2023/0099642 A1
(43) Pub. Date: Mar. 30, 2023

(54) TONER FOR DEVELOPING ELECTROSTATIC CHARGE IMAGE, ELECTROSTATIC CHARGE IMAGE DEVELOPER, AND TONER CARTRIDGE

(71) Applicant: FUJIFILM Business Innovation Corp., Tokyo (JP)

(72) Inventors: Moegi Iguchi, Kanagawa (JP); Sakon Takahashi, Kanagawa (JP); Yosuke Tsurumi, Kanagawa (JP); Yasuaki Hashimoto, Kanagawa (JP); Ryo Otake, Kanagawa (JP)

(73) Assignee: FUJIFILM Business Innovation Corp., Tokyo (JP)

(21) Appl. No.: 17/584,488

(22) Filed: Jan. 26, 2022

(30) Foreign Application Priority Data
Sep. 24, 2021 (JP) 2021-156191

(51) Int. Cl. G03G 9/097; G03G 9/08; G03G 15/08

(52) U.S. Cl. CPC G03G 9/09725; G03G 9/0819; G03G 9/0827; G03G 9/09708; G03G 9/0821; G03G 15/0865

(57) ABSTRACT

A toner for developing an electrostatic charge image contains toner particles having an average circularity Cc of 0.98 or more; and external additives including monodisperse silica particles having an average diameter of primary particles of 20 nm or more and 70 nm or less and titanate particles having an average diameter of primary particles of 20 nm or more and 70 nm or less, wherein the absolute difference between the average diameter of primary particles of the monodisperse silica particles and the average diameter of primary particles of the titanate particles is 25 nm or less.

### CROSS-REFERENCE TO RELATED APPLICATIONS

This application is based on and claims priority under 35 USC 119 from Japanese Patent Application No. 2021-156191 filed Sep. 24, 2021.

### BACKGROUND

### (i) Technical Field

The present disclosure relates to a toner for developing an electrostatic charge image, an electrostatic charge image developer, and a toner cartridge.

### (ii) Related Art

Japanese Unexamined Patent Application Publication No. 2019-109416 proposes “a toner comprising toner particles and an external additive, wherein the external additive includes inorganic fine particles A being titanic acid salt fine particles having a second group element and having a DA of 10 nm or more and 60 nm or less when a number average particle size (Dl) of primary particles of the titanic acid salt fine particles is DA; and fine silica particle B having a DB of 40 nm or more and 300 nm or less when a number average particle size (Dl) of primary particles is DB and having a density of 0.75 or more and 0.93 or less; a primary particle number average particle size ratio (DB/DA) of the fine silica particles B to the fine inorganic particles A is 1.0 or more and 20.0 or less; and an effective Ti ratio determined from the formula below, where Tie and Sie are a value of Ti elements originating in the titanic acid salt fine particles and a value derived from Si elements originating in the silica fine particles B, respectively, measured by observing a surface of the toner by X-ray photoelectron spectrometry (ESCA), and Tix and Six are a value of Ti elements originating in the titanic acid salt fine particles and a value derived from Si elements originating in the silica fine particles B, respectively, measured by observing the toner by fluorescent X-ray elemental analysis (XRF), is 0.20 or more and 0.60 or less:

Effective Ti ratio=(Tie/(Sie+Tie))/(Tix/(Six+Tix)).”

### SUMMARY

Aspects of non-limiting embodiments of the present disclosure relate to a toner for developing an electrostatic charge image, the toner containing toner particles having an average circularity Cc of 0.98 or more and external additives including monodisperse silica particles and titanate particles, and this toner may help reduce the event of the fixation of toner adhering to non-image areas (fogging) in repeated image formation under hot and humid conditions, compared with if the average diameter of primary particles of the monodisperse silica particles were less than 20 nm or more than 70 nm, if the average diameter of primary particles of the titanate particles were less than 20 nm or more than 70 nm, or if the absolute difference between the average diameter of primary particles of the monodisperse silica particles and that of the titanate particles were more than 25 nm.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a toner for developing an electrostatic charge image, the toner containing toner particles having an average circularity Cc of 0.98 or more; and external additives including monodisperse silica particles having an average diameter of primary particles of 20 nm or more and 70 nm or less and titanate particles having an average diameter of primary particles of 20 nm or more and 70 nm or less, wherein an absolute difference between the average diameter of primary particles of the monodisperse silica particles and the average diameter of primary particles of the titanate particles is 25 nm or less.

### BRIEF DESCRIPTION OF THE DRAWINGS

Exemplary embodiments of the present disclosure will be described in detail based on the following figures, wherein:

FIG. 1 is a schematic view of the structure of an image forming apparatus according to an exemplary embodiment; and

FIG. 2 is a schematic view of the structure of a process cartridge according to an exemplary embodiment.

### DETAILED DESCRIPTION

The following describes exemplary embodiments of the present disclosure. The following description and Examples are merely examples of the embodiments and do not limit the scope of the disclosure.

In the series of numerical ranges presented herein, the upper or lower limit of a numerical range may be substituted with that of another in the same series. The upper or lower limit of a numerical range, furthermore, may be substituted with a value indicated in the Examples section.

An ingredient may be a combination of multiple substances.

If a composition contains a combination of multiple substances as one of its ingredients, the amount of the ingredient represents the total amount of the substances in the composition unless stated otherwise.

### Toner for Developing an Electrostatic Charge Image

A toner according to an exemplary embodiment for developing an electrostatic charge image (hereinafter, toner for developing an electrostatic charge image may be referred to as “toner”) contains toner particles having an average circularity Cc of 0.98 or more and external additives including monodisperse silica particles having an average diameter of primary particles of 20 nm or more and 70 nm or less and titanate particles having an average diameter of primary particles of 20 nm or more and 70 nm or less.

The absolute difference between the average diameter of primary particles of the monodisperse silica particles and that of the titanate particles, furthermore, is 25 nm or less.

Configured as described above, the toner according to this exemplary embodiment may help reduce the event of the fixation of toner adhering to non-image areas (fogging) in repeated image formation under hot and humid conditions. A possible reason is as follows.

The field of electrophotographic image formation has seen growing demand for energy conservation, higher image quality, etc., in recent years. To meet these demands, researchers are developing toners for developing electrostatic charge images that contain toner particles having a high average circularity (e.g., toner particles having an average circularity of more than 0.98; hereinafter also spherical toner particles).

For example, spherical toner particles containing particles of a titanate, such as strontium titanate, as an external additive are robust against the impact of changes, for example in humidity and temperature, during image formation. Titanate particles, however, can tend to be positively charged by the triboelectric effect, and in that case it has been difficult to charge the toner at the developing component. In image formation under hot and humid conditions, therefore, such particles have caused image defects like fogging by making the toner adhere to non-image areas of the image carrier (e.g., a photoreceptor) during the process of development.

To address this, spherical toner particles containing titanate particles and silica particles as external additives are under development. Silica particles can tend to be negatively charged by the triboelectric effect. Even if the titanate particles are positively charged by the triboelectric effect, therefore, the positive charge on the silica particles makes the overall triboelectric charge on the external additives in the toner small. As a result, the toner is charged easily at the developing component. In image formation under hot and humid conditions, however, this type of toner has had disadvantages such as the penetration of the external silica particles, the separation of the external additives, and the aggregation of the external additives. With such a toner, therefore, image defects like fogging have been inevitable in image formation under hot and humid conditions.

The toner according to this exemplary embodiment contains external additives including monodisperse silica particles having an average diameter of primary particles of 20 nm or more and 70 nm or less and titanate particles having an average diameter of primary particles of 20 nm or more and 70 nm or less. An average diameter of primary particles of 20 nm or more for both the monodisperse silica and titanate particles may help limit the penetration of the external additives into the toner particles. An average diameter of primary particles of 70 nm or less for both the monodisperse silica and titanate particles, furthermore, may help limit the separation of the external additives from the toner particles.

In addition to this, the toner according to this embodiment is configured such that the absolute difference between the average diameter of primary particles of the monodisperse silica particles and that of the titanate particles is 25 nm or less. Diameters of particles of the external additives, the monodisperse silica and titanate particles, falling in this range may help them spread evenly on the surface of the toner particles. The reason is that in the macroscopic perspective, one set of particles charged positively and the other charged negatively have similar diameters, hence no repulsion or attraction occurs between the two sets of particles, and a good balance between the charges is achieved in consequence. As a result, the aggregation of the external additives may be limited.

For this reason, the inventors believe, the toner according to this exemplary embodiment may help reduce the event of the fixation of toner adhering to non-image areas (fogging) in repeated image formation under hot and humid conditions.

### Toner Particles

The toner particles contain, for example, a binder resin, optionally with a coloring agent, a release agent, and/or other additives.

### Binder Resin

The binder resin is a vinyl resin. Examples of vinyl resins include those that are homopolymers of polymerizable styrene monomers (e.g., styrene, para-chlorostyrene, and α-methylstyrene), polymerizable (meth)acrylic monomers (e.g., (meth)acrylic acid, methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, and 2-ethylhexyl methacrylate), polymerizable ethylenic unsaturated nitrile monomers (e.g., acrylonitrile and methacrylonitrile), polymerizable vinyl ether monomers (e.g., vinyl methyl ether and vinyl isobutyl ether), polymerizable vinyl ketone monomers (e.g., vinyl methyl ketone, vinyl ethyl ketone, and vinyl isopropenyl ketone), polymerizable olefin monomers (e.g., ethylene, propylene, and butadiene), and other polymerizable monomers or copolymers of two or more such polymerizable monomers.

Besides the vinyl resin, the binder resin may also include, for example, a non-vinyl resin, such as an epoxy, polyester, polyurethane, polyamide, cellulose, or polyether resin or modified rosin, a mixture of non-vinyl and vinyl resins, or a graft polymer obtained by polymerizing a vinyl monomer in the presence of a non-vinyl resin. Vinyl resins may constitute 50% by mass or more (preferably 80% by mass or more, more preferably 90% by mass or more) of all binder resins.

One such binder resin may be used alone, or two or more may be used in combination.

One specific example of a vinyl resin is a styrene-(meth)acrylic resin.

A styrene-(meth)acrylic resin is a copolymer of at least a polymerizable styrene monomer (polymerizable monomer having the styrene structure) and a polymerizable (meth)acrylic monomer (polymerizable monomer having the (meth)acryloyl structure).

The expression “(meth)acrylic” encompasses both “acrylic” and “methacrylic,” and the expression “(meth)acrylate” encompasses both an “acrylate” and a “methacrylate.”

Examples of polymerizable styrene monomers include styrene, alkylated styrenes (e.g., α-methylstyrene, 2-methylstyrene, 3-methylstyrene, 4-methylstyrene, 2-ethylstyrene, 3-ethylstyrene, and 4-ethylstyrene), halogenated styrenes (e.g., 2-chlorostyrene, 3-chlorostyrene, and 4-chlorostyrene), and vinylnaphthalene. One polymerizable styrene monomer may be used alone, or two or more may be used in combination.

Of these, styrene is highly reactive, easy to control in terms of its reaction, and readily available.

Examples of polymerizable (meth)acrylic monomers include (meth)acrylic acid and (meth)acrylates. Examples of (meth)acrylates include alkyl (meth)acrylates (e.g., methyl (meth)acrylate, ethyl (meth)acrylate, n-propyl (meth)acrylate, n-butyl (meth)acrylate, n-pentyl (meth)acrylate, n-hexyl acrylate, n-heptyl (meth)acrylate, n-octyl (meth)acrylate, n-decyl (meth)acrylate, n-dodecyl (meth)acrylate, n-lauryl (meth)acrylate, n-tetradecyl (meth)acrylate, n-hexadecyl (meth)acrylate, n-octadecyl (meth)acrylate, isopropyl (meth)acrylate, isobutyl (meth)acrylate, t-butyl (meth)acrylate, isopentyl (meth)acrylate, amyl (meth)acrylate, neopentyl (meth)acrylate, isohexyl (meth)acrylate, isoheptyl (meth)acrylate, isooctyl (meth)acrylate, 2-ethylhexyl (meth)acrylate, cyclohexyl (meth)acrylate, and t-butylcyclohexyl (meth)acrylate), aryl (meth)acrylates (e.g., phenyl (meth)acrylate, biphenyl (meth)acrylate, diphenylethyl (meth)acrylate, t-butylphenyl (meth)acrylate, and terphenyl (meth)acrylate), dimethylaminoethyl (meth)acrylate, diethylaminoethyl (meth)acrylate, methoxyethyl (meth)acrylate, 2-hydroxyethyl (meth)acrylate, β-carboxyethyl (meth)acrylate, and (meth)acrylamides. One polymerizable (meth)acrylic monomer may be used alone, or two or more may be used in combination.

The ratio between the polymerizable styrene monomer and the polymerizable (meth)acrylic monomer in the copolymer (by mass; polymerizable styrene monomer/polymerizable (meth)acrylic monomer) may be, for example, between 85/15 and 70/30.

A crosslinked styrene-(meth)acrylic resin may also be used. An example is a crosslinked copolymer of at least a polymerizable styrene monomer, a polymerizable (meth)acrylic monomer, and a crosslinking monomer.

An example of a crosslinking monomer is a crosslinking agent that has two or more functional groups.

Examples of bifunctional crosslinking agents include divinyl benzene, divinyl naphthalene, di(meth)acrylate compounds (e.g., diethylene glycol di(meth)acrylate, methylene bis(meth)acrylamide, decanediol diacrylate, and glycidyl (meth)acrylate), polyester-forming di(meth)acrylates, and 2-([1′-methylpropylideneamino]carboxyamino)ethyl methacrylate.

Examples of crosslinking agents having more than two functional groups include tri(meth)acrylate compounds (e.g., pentaerythritol tri(meth)acrylate, trimethylolethane tri(meth)acrylate, and trimethylolpropane tri(meth)acrylate), tetra(meth)acrylate compounds (e.g., tetramethylolmethane tetra(meth)acrylate and oligoester (meth)acrylates), 2,2-bis(4-methacryloxy, polyethoxyphenyl)propane, diallyl phthalate, triallyl cyanurate, triallyl isocyanurate, triallyl trimellitate, and diaryl chlorendate.

The ratio of the crosslinking monomer to all monomers in the copolymer (by mass; crosslinking monomer/all monomers) may be, for example, between 2/1000 and 30/1000.

The glass transition temperature (Tg) of the styrene-(meth)acrylic resin may be, for example, 50° C. or more and 75° C. or less, preferably 55° C. or more and 65° C. or less, more preferably 57° C. or more and 60° C. or less for fixation reasons.

The glass transition temperature is that determined from the DSC curve, measured by differential scanning calorimetry (DSC), and more specifically is the “extrapolated initial temperature of glass transition” as in the methods for determining glass transition temperatures set forth in JIS K7121-1987 “Testing Methods for Transition Temperatures of Plastics.”

The weight-average molecular weight of the styrene-(meth)acrylic resin may be, for example, 30000 or more and 200000 or less, preferably 40000 or more and 100000 or less, more preferably 50000 or more and 80000 or less for storage stability reasons.

The weight-average molecular weight is those measured by gel permeation chromatography (GPC). The analyzer is Tosoh's HLC-8120 GPC chromatograph with Tosoh's TSKgel SuperHM-M column (15 cm), and the eluate is tetrahydrofuran (THF). Comparing the measured data with a molecular-weight calibration curve prepared using monodisperse polystyrene standards gives the weight-average molecular weight.

The binder resin content may be, for example, 40% by mass or more and 95% by mass or less of the toner particles as a whole, preferably 50% by mass or more and 90% by mass or less, more preferably 60% by mass or more and 85% by mass or less.

### Coloring Agent

Examples of coloring agents include different pigments, such as carbon black, chrome yellow, Hansa yellow, benzidine yellow, threne yellow, quinoline yellow, pigment yellow, permanent orange GTR, pyrazolone orange, Vulcan orange, Watchung red, permanent red, brilliant carmine 3B, brilliant carmine 6B, DuPont oil red, pyrazolone red, lithol red, rhodamine B lake, lake red C, pigment red, rose bengal, aniline blue, ultramarine blue, Calco oil blue, methylene blue chloride, phthalocyanine blue, pigment blue, phthalocyanine green, and malachite green oxalate; and kinds of dyes, such as acridine, xanthene, azo, benzoquinone, azine, anthraquinone, thioindigo, dioxazine, thiazine, azomethine, indigo, phthalocyanine, aniline black, polymethine, triphenylmethane, diphenylmethane, and thiazole dyes.

One coloring agent may be used alone, or two or more may be used in combination.

Surface-treated coloring agents may optionally be used, and a combination of a coloring agent and a dispersant may also be used. It is also possible to use multiple coloring agents in combination.

The coloring agent content may be, for example, 1% by mass or more and 30% by mass or less of the toner particles as a whole, preferably 3% by mass or more and 15% by mass or less.

### Release Agent

Examples of release agents include hydrocarbon waxes; natural waxes, such as carnauba wax, rice wax, and candelilla wax; synthesized or mineral/petroleum waxes, such as montan wax; and ester waxes, such as fatty acid esters and montanates. Other release agents may also be used.

The melting temperature of the release agent may be 50° C. or more and 110° C. or less, preferably 60° C. or more and 100° C. or less.

The melting temperature is the “peak melting temperature” as in the methods for determining melting temperatures set forth in JIS K 7121-1987 “Testing Methods for Transition Temperatures of Plastics” and is determined from the DSC curve, measured by differential scanning calorimetry (DSC).

The release agent content may be, for example, 1% by mass or more and 20% by mass or less of the toner particles as a whole, preferably 5% by mass or more and 15% by mass or less.

### Other Additives

Examples of other additives include well-known additives, such as magnetic substances, charge control agents, and inorganic powders. Such additives are contained in the toner particles as internal additives.

### Characteristics and Other Details of the Toner Particles

The toner particles may be single-layer toner particles or may be “core-shell” toner particles, i.e., toner particles formed by a core (core particle) and a coating that covers the core (shell layer).

A possible structure of core-shell toner particles is one in which the core contains the binder resin together with the coloring agent, release agent, and/or other additives if used, and the coating contains the binder resin.

The volume-average diameter of the toner particles (D50v) may be 2 μm or more and 10 μm or less, preferably 4 μm or more and 8 μm or less.

Incidentally, the average diameters and geometric standard deviations of the toner particles are those measured using Coulter Multisizer II (Beckman Coulter) and ISOTON-II electrolyte (Beckman Coulter).

For measurement, a sample weighing 0.5 mg or more and 50 mg or less is added to 2 ml of a 5% by mass aqueous solution of a surfactant (e.g., a sodium alkylbenzene sulfonate), which will serve as a dispersant. The resulting dispersion is added to 100 ml or more and 150 ml or less of the electrolyte.

The electrolyte with the suspended sample therein is sonicated for 1 minute using a sonicator, and the size distribution of particles having a diameter of 2 μm or more and 60 μm or less is measured using Coulter Multisizer II with an aperture size of 100 μm. The number of particles sampled is 50000.

On particle size segments (channels) divided based on the measured size distribution, the cumulative distribution of volume and that of frequency are plotted starting from the smallest diameter, and, in the plots, the particle diameters at which the cumulative sum is 16% are defined as volume diameter D16v and number diameter D16p, the particle diameters at which the cumulative sum is 50% are defined as the volume-average diameter D50v and cumulative number-average diameter D50p, and the particle diameters at which the cumulative sum is 84% are defined as volume diameter D84v and number diameter D84p.

Using these, the geometric standard deviation by volume (GSDv) is given by (D84v/D16v)^{1/2}, and the geometric standard deviation by number (GSDp) is given by (D84p/D16p)^{1/2}.

The average circularity Cc of the toner particles is 0.98 or more.

The average circularity Cc of the toner particles is given by (circumference of the equivalent circle)/(circumference) [(circumference of circles having the same projected area as particle images)/(circumference of projected images of the particles)]. Specifically, the average circularity Cc of the toner particles can be measured as follows.

A portion of the toner particles of interest is collected by aspiration in such a manner that it will form a flat stream, this flat stream is photographed with a flash to capture the figures of the particles in a still image, then the images of particles are analyzed using a flow particle-image analyzer (Sysmex FPIA-3000), and the average circularity is determined from the results. In the determination of the average circularity, the number of particles sampled is 3500.

The external additives contained in the toner are removed beforehand by dispersing the toner (developer) of interest in water containing a surfactant and then sonicating the resulting dispersion.

### External Additives

The external additives include monodisperse silica particles having an average diameter of primary particles of 20 nm or more and 70 nm or less and titanate particles having an average diameter of primary particles of 20 nm or more and 70 nm or less.

### Monodisperse Silica Particles

The monodisperse silica particles can be any kind of silica-based, or SiO₂-based, particles. As mentioned herein, being “-based” means the material is a mixture of multiple components in which the component indicated constitutes 50% by mass or more of the total mass of the mixture.

As mentioned herein, furthermore, “monodisperse” means the geometric standard deviation as defined below is 1.25 or less.

The monodisperse silica particles have an average diameter of primary particles of 20 nm or more and 70 nm or less.

For the penetration of the monodisperse silica particles into the toner particles and their separation from the toner particles to be further limited, and for fogging in repeated image formation under hot and humid conditions to be further reduced in consequence, the average diameter of primary particles of the monodisperse silica particles may be 25 nm or more and 70 nm or less, preferably 30 nm or more and 65 nm or less, more preferably 35 nm or more and 65 nm or less.

The geometric standard deviation of the monodisperse silica particles is 1.25 or less.

For the aggregation of the monodisperse silica particles to be further limited, and for fogging in repeated image formation under hot and humid conditions to be further reduced in consequence, the geometric standard deviation of the monodisperse silica particles may be 1.05 or more and 1.25 or less, preferably 1.05 or more and 1.2 or less, more preferably 1.05 or more and 1.15 or less.

The average diameter of primary particles and geometric standard deviation of the monodisperse silica particles in this context are those measured as follows.

The silica particles of interest are dispersed in matrix resin particles having a volume-average diameter of 100 μm (e.g., a polyester resin; weight-average molecular weight Mw=500000), and primary particles in the dispersion are observed using a scanning electron microscope (SEM; 5-4100, Hitachi) and imaged (magnification, 40000). Image information from 200 randomly selected silica particles of interest is put into an image analyzer (WinROOF), the images are analyzed to measure the area of each particle, and the measured areas are used to calculate equivalent circular diameters. The equivalent circular diameter at which the cumulative sum of frequency by volume is 50% is the average diameter of primary particles.

Then the equivalent circular diameters at which the cumulative frequency by volume is 16% (D16) and 84% (D84) are determined. The square root of the 84% diameter (D84) divided by the 16% diameter (D16) is the geometric standard deviation (=(D84/D16)^{1/2}). It should be noted that the magnification of the electron microscope is adjusted so that about 10 or more and 50 or less silica particles of interest will be seen in each field of view, and multiple fields of view are combined for the determination of the equivalent circular diameters of primary particles.

The surface of the monodisperse silica particles may have been rendered hydrophobic. The hydrophobic treatment is done by, for example, immersing the monodisperse silica particles in a hydrophobizing agent. The hydrophobizing agent can be of any kind, but examples include known organic silicon compounds having an alkyl group (e.g., the methyl, ethyl, propyl, or butyl group), specifically silane coupling agents that are silazane compounds (e.g., silane compounds, such as methyltrimethoxysilane, dimethyldimethoxysilane, trimethylchlorosilane, and trimethylmethoxisilane; hexamethyldisilazane; and tetramethyldisilazane). Silicone oil, titanate coupling agents, and aluminum coupling agents are also examples of hydrophobizing agents. One such agent may be used alone, or two or more may be used in combination.

The amount of the hydrophobizing agent can be, for example, 1 part by mass or more and 200 parts by mass or less per 100 parts by mass of the monodisperse silica particles.

The quantity of the monodisperse silica particles may be 0.01% by mass or more and 10% by mass or less, preferably 0.05% by mass or more and 5% by mass or less, more preferably 0.1% by mass or more and 2.5% by mass or less of the mass of the toner particles.

### Production of the Monodisperse Silica Particles

The monodisperse silica particles may be produced by a wet process.

In this exemplary embodiment, “a wet process” is differentiated from a gas-phase process and is one in which the silica particles are produced by neutralizing sodium silicate with a mineral acid or hydrolyzing an alkoxysilane.

Of wet processes, the sol-gel process in particular may be used to produce the monodisperse silica particles.

The following describes how to produce the monodisperse silica particles used in this exemplary embodiment, by taking the example of the sol-gel process.

The method for producing the monodisperse silica particles, however, does not need to be by this sol-gel process.

The diameter of the monodisperse silica particles can be controlled freely by the ratio by weight between the alkoxysilane, ammonia, alcohol, and water, reaction temperature, stirring speed, and rates of feeding in the hydrolysis and condensation polymerization in the sol-gel process.

The following describes the production of the monodisperse silica particles by the sol-gel process in specific terms.

That is, tetramethoxysilane is added dropwise to a solution containing water, an alcohol, and aqueous ammonia as a catalyst while the mixture is stirred with heating. Removing the solvents from the resulting silica sol suspension, or drying the suspension, will give the desired monodisperse silica particles.

After that, the resulting monodisperse silica particles may optionally be treated to be hydrophobic.

In addition, when the monodisperse silica particles are produced by the sol-gel process, their surface may be rendered hydrophobic at the same time.

In that case, the silica sol suspension resulting from reaction as described above is centrifuged to separate it into wet silica gel, the alcohol, and aqueous ammonia, then a solvent is added to the wet silica gel to reconstitute it into a silica sol, and a hydrophobizing agent is added to render the surface of the silica particles hydrophobic. Removing the solvents from this hydrophobic silica sol, or drying the silica sol, will give the desired monodisperse silica particles.

The monodisperse silica particles obtained in such a way may be subjected to a hydrophobic treatment once again.

The treatment for rendering the surface of the silica particles hydrophobic may be done by, for example, a dry process, such as spray drying, in which the silica particles are allowed to float in a gas phase and sprayed with a hydrophobizing agent or a solution containing it in that state; by a wet process, in which the silica particles are immersed in a solution containing a hydrophobizing agent and dried; or by mixing, in which a hydrophobizing agent and the silica particles are mixed together in a mixer.

After the surface of the silica particles is rendered hydrophobic, extra operations may follow, such as washing the silica particles with a solvent to remove the residual hydrophobizing agent and low-boiling-point residues.

### Titanate Particles

The titanate particles can be any kind of titanate-based particles.

A titanate is a salt that is called metatitanate and is formed by, for example, titanium oxide and another metal oxide or metal carbonate.

The titanate particles may be particles of an alkaline earth metal titanate.

In this context, an alkaline earth metal titanate is a salt represented by general formula RTiO₃ (where R represents one or two or more alkaline earth metals).

Using particles of an alkaline earth metal titanate, which reach their saturation charge quickly, as the titanate particles may help further reduce fogging in repeated image formation under hot and humid conditions.

Specific examples of titanate particles include particles of strontium titanate (SrTiO₃), calcium titanate (CaTiO₃), magnesium titanate (MgTiO₃), barium titanate (BaTiO₃), zinc titanate (PbTiO₃), etc.

For fogging in repeated image formation under hot and humid conditions to be further reduced, the titanate particles may be at least one selected from the group consisting of particles of strontium titanate, particles of calcium titanate, and particles of magnesium titanate.

One type of such titanate particles may be used alone, or two or more types may be used in combination.

The titanate particles have an average diameter of primary particles of 20 nm or more and 70 nm or less.

For the penetration of the titanate particles into the toner particles and their separation from the toner particles to be further limited, and for fogging in repeated image formation under hot and humid conditions to be further reduced in consequence, the average diameter of primary particles of the titanate particles may be 25 nm or more and 70 nm or less, preferably 30 nm or more and 65 nm or less, more preferably 35 nm or more and 55 nm or less.

The calculation of the average diameter of primary particles of the titanate particles is the same as that of the average diameter of primary particles of the monodisperse silica particles.

The titanate particles may contain a dopant.

A dopant in the titanate particles makes the titanate less crystalline and moderately angulated. This may help, for example, ensure the average circularity Cb of the titanate particles will be more than 0.78 and less than 0.94. When their average circularity is in this range, the titanate particles are fixed on the surface of the toner particles easily. The separation of the titanate particles from the toner particles, therefore, are further limited. As a result, the inventors believe, fogging in repeated image formation under hot and humid conditions is further reduced.

The dopant in the titanate particles may be a metal element that, when ionized, has an ionic radius that allows the ions to penetrate into the crystal structure of the titanate particles. In this regard, the dopant in the titanate particles may be a metal element that has an ionic radius of 40 μm or more and 200 μm or less when ionized, preferably a metal element having an ionic radius of 60 pm or more and 150 μm or less.

Specific examples of dopants in the titanate particles include lanthanides, silica, aluminum, magnesium, calcium, barium, vanadium, chromium, manganese, iron, cobalt, nickel, copper, zinc, gallium, niobium, molybdenum, ruthenium, palladium, indium, antimony, tantalum, tungsten, rhenium, iridium, platinum, bismuth, yttrium, zirconium, niobium, silver, and tin. Examples of lanthanides include lanthanum and cerium. Of these, at least one of lanthanum or silica in particular may be used because they have an ionic radius more suitable for ionic penetration into the crystal structure of particles of strontium titanate and are more effective than the others in making the titanate moderately angulated than the others.

The dopant concentration of the titanate particles may be such that the dopant constitutes 0.1 mol % or more and 20 mol % or less of alkaline earth metal atoms in the titanate particles, preferably such that the dopant constitutes 0.1 mol % or more and 15 mol % or less, more preferably 0.1 mol % or more and 10 mol % or less, of the alkaline earth metal atoms for the titanate to be moderately angulated.

The surface of the titanate particles may have been rendered hydrophobic. Examples of hydrophobizing agents include known surface treatment agents, specifically silane coupling agents, silicone oil, etc.

Examples of silane coupling agents include hexamethyldisilazane, trimethylsilane, trimethylchlorosilane, dimethyldichlorosilane, methyltrichlorosilane, allyldimethylchlorosilane, benzyldimethylchlorosilane, methyltrimethoxysilane, methyltriethoxysilane, isobutyltrimethoxysilane, dimethyldimethoxysilane, dimethyldiethoxysilane, trimethylmethoxysilane, hydroxypropyltrimethoxysilane, phenyltrimethoxysilane, n-butyltrimethoxysilane, n-hexadecyltrimethoxysilane, n-octadecyltrimethoxysilane, vinyltrimethoxysilane, vinyltriethoxysilane, γ-methacryloxypropyltrimethoxysilane, and vinyltriacetoxysilane.

Examples of silicone oils include dimethylpolysiloxane, methyl hydrogen polysiloxane, and methylphenylpolysiloxane.

The relative quantity of the titanate particles to that of the monodisperse silica particles expressed as a ratio by mass may be 0.1 or more and 10 or less, preferably 0.3 or more and 8 or less, more preferably 0.4 or more and 5 or less.

The quantity of the titanate particles may be 0.01% by mass or more and 5% by mass or less, preferably 0.05% by mass or more and 3% by mass or less, more preferably 0.1% by mass or more and 2% by mass or less of the mass of the toner particles.

### Production of the Titanate Particles

It is not critical how to produce the titanate particles, but they may be produced by a wet process for the control of their shape and diameter.

An example of wet production of the titanate particles is to add an aqueous alkali solution to a liquid mixture of sources of the metal elements to be contained in the titanate while allowing the reaction to proceed, and then treat the product with an acid. In this production process, the diameter of the titanate particles is controlled by, for example, the ratio between the metal element sources, the initial concentrations of the metal element sources, the temperature of the aqueous alkali solution when it is added, and the rate of addition of the aqueous alkali solution.

An example of sources of the metal elements to be contained in the titanate is a hydrolysate of a titanium compound peptized with a mineral acid and a nitrate, chloride, or similar form of compound containing the metal element other than titanium.

Specifically, if the titanate particles are particles of an alkaline earth metal titanate, an example is a hydrolysate of a titanium compound peptized with a mineral acid and a nitrate, chloride, or similar form of compound containing the alkaline earth metal element.

More specifically, if the titanate particles are strontium titanate particles, an example is a hydrolysate of a titanium compound peptized with a mineral acid (hereinafter also referred to as a titanium source) and strontium nitrate, strontium chloride, or a similar form of strontium compound (hereinafter also referred to as a strontium source).

The following describes how to produce the titanate particles by taking the example of the production of strontium titanate particles, although this is not the only possible method.

The ratio between the titanium oxide and strontium sources may be 0.9 or more and 1.4 or less, preferably 1.05 or more and 1.20 or less, as a SrO/TiO₂ ratio by the number of moles. The initial concentration of the titanium oxide source may be 0.05 moles/L or more and 1.3 moles/L or less, preferably 0.5 moles/L or more and 1.0 mole/L or less, on a TiO₂ basis.

A dopant source may be added to the liquid mixture of the titanium oxide and strontium sources. An example of a dopant source is an oxide of a metal that is not titanium or strontium. The metal oxide as a dopant source is added in the form of a solution, for example in nitric acid, hydrochloric acid, or sulfuric acid. The amount of added dopant source may be such that the dopant metal will constitute 0.1 moles or more and 10 moles or less per 100 moles of strontium, preferably such that the dopant metal will constitute 0.5 moles or more and 10 moles or less.

Alternatively, the dopant source may be added when the aqueous alkali solution is added to the liquid mixture of the titanium oxide and strontium sources. In that case, too, the metal oxide as a dopant source can be added in the form of a solution in nitric acid, hydrochloric acid, or sulfuric acid.

The aqueous alkali solution may be an aqueous solution of sodium hydroxide. Regarding the temperature of the aqueous alkali solution when it is added, the resulting strontium titanate particles tend to be better in crystallinity with increasing temperature, and in this exemplary embodiment, this temperature may be 60° C. or more and 100° C. or less.

As for the rate of addition of the aqueous alkali solution, the resulting strontium titanate particles have a larger diameter with slower rates of addition, and have a smaller diameter with faster rates of addition. The rate of addition of the aqueous alkali solution is, for example, 0.001 equivalents/h or more and 1.2 equivalents/h or less, preferably 0.002 equivalents/h or more and 1.1 equivalents/h or less, based on the raw materials to which the solution is added.

After the addition of the aqueous alkali solution, the product is treated with an acid to remove unreacted strontium source. In the acid treatment, the pH of the reaction solution is adjusted to 2.5 to 7.0, preferably 4.5 to 6.0, for example with hydrochloric acid.

After the acid treatment, the reaction solution is separated into solid and liquid fractions, and the solid fraction is dried to give strontium titanate particles.

By customizing parameters for the drying of the solid fraction, the water content of the strontium titanate particles is controlled.

If the surface of the strontium titanate particles is rendered hydrophobic, the water content may be controlled by customizing parameters for drying after the hydrophobic treatment.

An example of drying parameters that may be used In controlling the water content is a drying temperature of 90° C. or more and 300° C. or less (preferably 100° C. or more and 150° C. or less) and a duration of drying of 1 hour or more and 15 hours or less (preferably 5 hours or more and 10 hours or less).

### Hydrophobic Treatment

The treatment for rendering the surface of the strontium titanate particles hydrophobic is done by, for example, preparing a treatment liquid by mixing a hydrophobizing agent and a solvent, mixing the strontium titanate particles and the treatment liquid together with stirring, and continuing stirring the mixture.

After the surface treatment, the mixture is dried to remove the solvent in the treatment liquid.

Examples of hydrophobizing agents are the same as mentioned above.

Examples of solvents that may be used to prepare the treatment liquid include alcohols (e.g., methanol, ethanol, propanol, and butanol) and hydrocarbons (e.g., benzene, toluene, normal hexane, and normal heptane).

The concentration of the hydrophobizing agent in the treatment liquid may be 1% by mass or more and 50% by mass or less, preferably 5% by mass or more and 40% by mass or less, more preferably 10% by mass or more and 30% by mass or less.

As stated, the amount of hydrophobizing agent used in the hydrophobic treatment may be 1% by mass or more and 50% by mass or less, preferably 5% by mass or more and 40% by mass or less, more preferably 5% by mass or more and 30% by mass or less, even more preferably 10% by mass or more and 25% by mass or less of the mass of the strontium titanate particles.

### Extra External Additive

The toner used in this exemplary embodiment may contain, as an extra external additive, extra particles that are not the monodisperse silica particles or the titanate particles.

An example of extra particles is inorganic particles that are not silica particles or titanate particles.

Examples of inorganic particles include particles of Al₂O₃, CuO, ZnO, SnO₂, CeO₂, Fe₂O₃, MgO, BaO, CaO, K₂O, Na₂O, ZrO₂, CaO.SiO₂, K₂O.(TiO₂)ₙ, Al₂O₃.2SiO₂, CaCO₃, MgCO₃, BaSO₄, and MgSO₄.

The surface of the inorganic particles as an extra external additive may have been rendered hydrophobic. The hydrophobic treatment is done by, for example, immersing the inorganic particles in a hydrophobizing agent. The hydrophobizing agent can be of any kind, but examples include silane coupling agents, silicone oil, titanate coupling agents, and aluminum coupling agents. One such agent may be used alone, or two or more may be used in combination.

The amount of the hydrophobizing agent may be 1 part by mass or more and 10 parts by mass or less per 100 parts by mass of the inorganic particles.

Particles like resin particles (particles of polystyrene, polymethyl methacrylate, melamine resins, etc.) and active cleaning agents (e.g., particles of fluoropolymers) are also examples of extra particles.

If the toner contains an extra external additive, the amount of the extra external additive may be 1% by mass or more and 99% by mass or less, preferably 10% by mass or more and 90% by mass or less, more preferably 20% by mass or more and 85% by mass or less of the total amount of external additives.

### Characteristics of the External Additives

### Absolute Difference in the Average Diameter of Primary Particles

The absolute difference between the average diameter of primary particles of the monodisperse silica particles and that of the titanate particles is 25 nm or less.

For fogging in repeated image formation under hot and humid conditions to be further reduced, the absolute difference between the average diameter of primary particles of the monodisperse silica particles and that of the titanate particles may be 0 nm or more and 18 nm or less, preferably 2 nm or more and 16 nm or less, more preferably 4 nm or more and 14 nm or less.

### Average Circularities Ca and Cb

The average circularity Ca of the monodisperse silica particles may be more than 0.86 and less than 0.94, and the average circularity Cb of the titanate particles may be more than 0.78 and less than 0.94 at the same time.

Average circularities of the monodisperse silica and titanate particles in these ranges may help further reduce fogging in repeated image formation under hot and humid conditions.

A possible reason is as follows.

Giving the monodisperse silica and titanate particles average circularities Ca and Cb in the above ranges means making the shape of both two sets of particles moderately irregular. Their irregular shape will prevent the monodisperse silica and titanate particles from rolling on the toner particles easily, further limiting the aggregation of the external additives. For this reason, the inventors believe, average circularities Ca and Cb of the monodisperse silica and titanate particles in the above ranges may help further reduce fogging in repeated image formation under hot and humid conditions.

For fogging in repeated image formation under hot and humid conditions to be further reduced, the average circularity Ca of the monodisperse silica particles may be 0.87 or more and 0.93 or less, preferably 0.88 or more and 0.92 or less. For fogging in repeated image formation under hot and humid conditions to be further reduced, furthermore, the average circularity Cb of the titanate particles may be 0.79 or more and 0.93 or less, preferably 0.80 or more and 0.92 or less.

The average circularity Ca of the monodisperse silica particles may be larger than the average circularity Cb of the titanate particles.

Giving the monodisperse silica and titanate particles average circularities Ca and Cb in such a relationship means making the titanate particles angulated compared with the monodisperse silica particles. In that case the titanate particles, compared with the monodisperse silica particles, will become fixed on the surface of the toner particles easily. The monodisperse silica particles, on the other hand, are round compared with the titanate particles. The monodisperse silica particles, therefore, will easily roll on the surface of the toner particles compared with the titanate particles and tend to adhere to portions not occupied by the titanate particles on the surface of the toner particles. By virtue of these, the monodisperse silica and titanate particles will be even less likely to separate from the toner particles, and the aggregation of the external additives will also be further limited. For this reason, the inventors believe, making the average circularity Ca of the monodisperse silica particles larger than the average circularity Cb of the titanate particles may help further reduce fogging in repeated image formation under hot and humid conditions.

The average circularities of the monodisperse silica and titanate particles in this context are those measured as follows.

The particles of interest (monodisperse silica or titanate particles) are dispersed in matrix resin particles having a volume-average diameter of 100 μm (e.g., a polyester resin; weight-average molecular weight Mw=500000), and primary particles in the dispersion are observed using a scanning electron microscope (SEM; S-4100, Hitachi) and imaged (magnification, 40000). Image data from 200 randomly selected particles of interest is put into an image analyzer (WinROOF), the 2D images of primary particles are analyzed, and from the results the circularity is determined according to the formula below:

Circularity=(4π×A)/I²

(where I represents the circumference of the primary particle on the image, and A represents the projected area of the primary particle).

In the cumulative distribution of frequency by circularity from 200 primary particles obtained from the analysis of their 2D images, the circularity at which the cumulative sum is 50% is the average circularity of the particles (monodisperse silica or titanate).

### Relative Density Da of the Monodisperse Silica Particles and Relative Density db of the Titanate Particles

The relative density Da of the monodisperse silica particles may be 1.1 or more and 1.3 or less, and the relative density db of the titanate particles may be larger than the relative density Da of the monodisperse silica particles at the same time.

Giving the monodisperse silica and titanate particles relative densities Da and db in such a relationship may help further reduce fogging in repeated image formation under hot and humid conditions.

A possible reason is as follows.

Titanate particles having a relative density db larger than the relative density Da of the monodisperse silica particles will preferentially adhere to the surface of the toner particles when the monodisperse silica and titanate particles are added to the toner particles as external additives. The monodisperse silica particles, therefore, will tend to adhere to portions not occupied by the titanate particles on the surface of the toner particles. The aggregation of the monodisperse silica and titanate particles will also be further limited. For this reason, the inventors believe, giving the monodisperse silica and titanate particles relative densities in the above range may help further reduce fogging in repeated image formation under hot and humid conditions.

The relative density db of the titanate particles may be 4.0 or more and 6.5 or less, preferably 4.1 or more and 5.5 or less, more preferably 4.2 or more and 5.0 or less.

When with a relative density db in any of these ranges, the titanate particles tend to be more adhesive to the surface of the toner particles. In that case, therefore, the monodisperse silica and titanate particles will be even less likely to separate from the toner particles, and the aggregation of the external additives will also be further limited. As a result, the inventors believe, fogging in repeated image formation under hot and humid conditions may be further reduced.

The relative density Da of the monodisperse silica particles and that db of the titanate particles are those measured using a Le Chatelier flask in accordance with JIS K 0061 (2001). The procedure is as follows.

(1) Put about 250 ml of ethyl alcohol into the Le Chatelier flask and adjust the meniscus to a mark.

(2) Immerse the flask into a temperature-controlled water bath and read the exact position of the meniscus against the scale on the flask when the liquid temperature is 20.0±0.2° C. (resolution, 0.025 ml)

(3) Take about 100 g of the sample and measure its mass W (g).

(4) Put the measured sample into the flask and eliminate bubbles.

(5) Immerse the flask into a temperature-controlled water bath and read the exact position of the meniscus against the scale on the flask when the liquid temperature is 20.0±0.2° C. (resolution, 0.025 ml)

(6) Calculate the relative density according to the following formulae:

D=W/(L2−L1)

ρ=D/0.9982

where D is the density (g/cm³) of the sample (20° C.), ρ is the relative density of the sample (20° C.), W is the apparent mass (g) of the sample, L1 is the meniscus reading (ml) before the sample is put into the flask (20° C.), L2 is the meniscus reading (ml) after the sample is put into the flask (20° C.), and 0.9982 is the density of water (g/cm³) at 20° C.

### Production of the Toner

The following describes how to produce the toner according to this exemplary embodiment.

The toner according to this exemplary embodiment can be obtained by producing the toner particles and then adding the external additives to the toner particles.

The toner particles can be produced either by a dry process (e.g., kneading and milling) or by a wet process (e.g., aggregation and coalescence, suspension polymerization, or dissolution and suspension). Any known dry or wet process may be used to produce the toner particles.

Of these, suspension polymerization in particular may help give the toner particles an average circularity Cc of 0.98 or more.

A specific example of how to produce the toner particles by suspension polymerization is by preparing a polymerizable monomer composition, a composition that contains at least a polymerizable monomer that gives the binder resin when polymerized (preparation of a polymerizable monomer composition), mixing the polymerizable monomer composition and an aqueous dispersion medium together to give a suspension (preparation of a suspension), and polymerizing the polymerizable monomer in the suspension to form the toner particles (polymerization).

The following describes this example in detail. It should be noted that the process described below gives toner particles that contain a coloring agent and a release agent, but the use of coloring and release agents is optional. Naturally, other additives may also be used.

### Preparation a Polymerizable Monomer Composition

A polymerizable monomer composition is prepared by mixing, dissolving, or dispersing at least one polymerizable monomer (optionally including a crosslinking monomer) that gives the binder resin when polymerized, a coloring agent, and a release agent. Besides the aforementioned additives, well-known additives, such as an organic solvent and a polymerization initiator, may be mixed, dissolved, or dispersed in the polymerizable monomer composition.

A tool that can be used to prepare the polymerizable monomer composition is a mixer, such as a homogenizer, ball mill, or sonicator.

Examples of polymerization initiators include well-known ones, such as organic peroxides (e.g., di-t-butyl peroxide, benzoyl peroxide, t-butyl peroxy-2-ethylhexanoate, t-hexyl peroxy-2-ethylhexanoate, t-butyl peroxypivalate, diisopropyl peroxydicarbonate, di-t-butyl peroxyisophthalate, and t-butyl peroxyisobutyrate), inorganic persulfate (e.g., potassium persulfate and ammonium persulfate), and azo compounds (4,4′-azobis(4-cyanovaleric acid), 2,2′-azobis(2-methyl-N-(2-hydroxyethyl)propionamide), 2,2′-azobis(2-amidinopropane)dihydrochloride, 2,2′-azobis(2,4-dimethylvaleronitrile), and 2,2′-azobisisobutyronitrile).

The amount of the polymerization initiator may be 0.1 parts by mass or more and 20 parts by mass or less, preferably 0.3 parts by mass or more and 15 parts by mass or less, more preferably 1.0 part by mass or more and 10 parts by mass or less per 100 parts by mass of the polymerizable monomer.

The polymerization initiator may be added to the polymerizable monomer composition, but it may instead be added in the preparation of a suspension, described below, to the aqueous medium before the composition is suspended therein.

### Preparation of a Suspension

The polymerizable monomer composition is suspended in an aqueous medium, for example by mixing the polymerizable monomer composition and the aqueous medium together, to give a suspension. That is, droplets of the polymerizable monomer composition are formed in the aqueous medium.

A tool that can be used to prepare the suspension is a mixer, such as a homogenizer, ball mill, or sonicator.

Examples of aqueous media include simply water and a mixture containing water and an aqueous medium (e.g., a lower alcohol or lower ketone).

The aqueous medium may contain a dispersion stabilizer.

Examples of dispersion stabilizers include organic ones and inorganic ones. Examples of organic dispersion stabilizers include surfactants (e.g., anionic, nonionic, and amphoteric surfactants), aqueous polymers (e.g., polyvinyl alcohol, methylcellulose, and gelatin), and sulfates. Examples of inorganic dispersion stabilizers include sulfates (e.g., barium sulfate and calcium sulfate), carbonates (e.g., barium carbonate, calcium carbonate, and magnesium carbonate), phosphates (e.g., calcium phosphate), metal oxides (e.g., aluminum oxide and titanium oxide), and metal hydroxides (e.g., aluminum hydroxide, magnesium hydroxide, and ferric hydroxide). One dispersion stabilizer may be used alone, or two or more may be used in combination.

The amount of the dispersion stabilizer may be 0.1 parts by mass or more and 20 parts or less, preferably 0.2 parts by mass or more and 10 parts by mass or less, per 100 parts by mass of the polymerizable monomer.

### Polymerization

The polymerizable monomer is polymerized, for example by heating the suspension, to form the toner particles. That is, the polymerizable monomer is polymerized inside the droplets of the polymerizable monomer composition dispersed in the suspension to produce the binder resin, thereby forming toner particles containing the binder resin, a coloring agent, and a release agent.

The temperature at which the polymerizable monomer is polymerized may be 50° C. or more, preferably 60° C. or more and 98° C. or less. The duration of polymerization of the polymerizable monomer may be 1 hour or more and 20 hours or less, preferably 2 hours or more and 15 hours or less. The suspension may be stirred while the polymerizable monomer is polymerizing.

In this way, the toner particles are obtained.

The resulting toner particles may be used as core particles (cores) on which a shell layer is formed by a well-known process, such as in situ polymerization or phase separation, to give core-shell toner particles. An in situ polymerization-based formation, for example, of the shell layer is by adding a polymerizable monomer that gives the binder resin when polymerized (polymerizable monomer that will give the resin for forming the shell layer) (and optionally a polymerization initiator) to the aqueous medium with dispersed core particles therein, and polymerizing the monomer to form a resin to cover the surface of the core particles. This gives core-shell toner particles composed of core particles (cores) and a shell layer formed on their surface.

The formation of the shell layer on the surface of the core particles (cores) may be done after removing any dispersion stabilizer in the aqueous medium with dispersed core particles therein or without removing it.

After the polymerization, the toner particles formed in the aqueous medium are washed, separated from the medium, and dried by known methods to give dry toner particles.

The washing may include adding an acid or alkali to the aqueous medium with dispersed toner particles therein to remove any dispersion stabilizer. A specific example is to add a well-known acid to remove an acid-soluble dispersion stabilizer or a well-known alkali to remove an alkali-soluble dispersion stabilizer.

The separation can be by any method, but techniques such as suction filtration and pressure filtration may help increase productivity.

The drying, too, can be by any method, but techniques such as lyophilization, flash drying, fluidized drying, and vibrating fluidized drying may help increase productivity.

Then the toner according to this exemplary embodiment is produced, for example by adding the external additives to the resulting dry toner particles and mixing them together. The mixing may be done using, for example, a V-blender, Henschel mixer, or Lödige mixer. Optionally, coarse particles of toner may be removed, for example using a vibrating sieve or air-jet sieve.

### Electrostatic Charge Image Developer

An electrostatic charge image developer according to an exemplary embodiment contains at least toner according to the above exemplary embodiment.

The electrostatic charge image developer according to this exemplary embodiment may be a one-component developer, which is substantially toner according to the above exemplary embodiment, or may be a two-component developer, which is a mixture of the toner and a carrier.

The carrier can be of any kind and can be a known one. Examples include a coated carrier, formed by a core magnetic powder and a coating resin on its surface; a magnetic powder-dispersed carrier, formed by a matrix resin and a magnetic powder dispersed therein; and a resin-impregnated carrier, which is a porous magnetic powder impregnated with resin.

The particles as a component of a magnetic powder-dispersed or resin-impregnated carrier can serve as the core material; a carrier obtained by coating the surface of them with resin may also be used.

The magnetic powder can be, for example, a powder of a magnetic metal, such as iron, nickel, or cobalt, or a powder of a magnetic oxide, such as ferrite or magnetite.

The coating or matrix resin can be, for example, polyethylene, polypropylene, polystyrene, polyvinyl acetate, polyvinyl alcohol, polyvinyl butyral, polyvinyl chloride, polyvinyl ether, polyvinyl ketone, a vinyl chloride-vinyl acetate copolymer, a styrene-acrylate copolymer, a straight silicone resin (resin having organosiloxane bonds) or its modified form, a fluoropolymer, polyester, polycarbonate, a phenolic resin, or an epoxy resin.

The coating or matrix resin may contain additives, such as electrically conductive particles.

Examples of electrically conductive particles include particles of metal, such as gold, silver, or copper, and particles of carbon black, titanium oxide, zinc oxide, tin oxide, barium sulfate, aluminum borate, and potassium titanate.

The resin coating of the surface of the core material can be achieved by, for example, coating the surface with a coating-layer solution prepared by dissolving the coating resin in a solvent, optionally with additives. The solvent can be of any kind and can be selected considering, for example, the coating resin used and suitability for coating.

Specific examples of how to provide the resin coating include dipping, i.e., immersing the core material in the coating-layer solution; spraying, i.e., applying a mist of the coating-layer solution onto the surface of the core material; fluidized bed coating, i.e., applying a mist of the coating-layer solution to core material floated on a stream of air; and kneader-coater coating, i.e., mixing the carrier core material and the coating-layer solution in a kneader-coater and removing the solvent.

If the developer is two-component, the mix ratio (by mass) between the toner and the carrier may be between 1:100 (toner:carrier) and 30:100, preferably between 3:100 and 20:100.

### Image Forming Apparatus/Image Forming Method

The following describes an image forming apparatus/image forming method according to an exemplary embodiment.

An image forming apparatus according to this exemplary embodiment includes an image carrier; a charging component that charges the surface of the image carrier; an electrostatic charge image creating component that creates an electrostatic charge image on the charged surface of the image carrier; a developing component that contains an electrostatic charge image developer and develops, using the electrostatic charge image developer, the electrostatic charge image on the surface of the image carrier to form a toner image; a transfer component that transfers the toner image on the surface of the image carrier to the surface of a recording medium; and a fixing component that fixes the toner image on the surface of the recording medium. The electrostatic charge image developer is an electrostatic charge developer according to the above exemplary embodiment.

The image forming apparatus according to this exemplary embodiment performs an image forming method that includes charging the surface of an image carrier; creating an electrostatic charge image on the charged surface of the image carrier; developing, using an electrostatic charge image developer according to the above exemplary embodiment, the electrostatic charge image on the surface of the image carrier to form a toner image; transferring the toner image on the surface of the image carrier to the surface of a recording medium; and fixing the toner image on the surface of the recording medium (image forming method according to this exemplary embodiment).

The configuration of the image forming apparatus according to this exemplary embodiment can be applied to well-known types of image forming apparatuses, including a direct-transfer image forming apparatus, which forms a toner image on the surface of an image carrier and transfers it directly to a recording medium; an intermediate-transfer image forming apparatus, which forms a toner image on the surface of an image carrier, transfers it to the surface of an intermediate transfer body (first transfer), and then transfers the toner image on the surface of the intermediate transfer body to the surface of a recording medium (second transfer); an image forming apparatus having a cleaning component that cleans the surface of the image carrier between the transfer of the toner image and charging; and an image forming apparatus having a static eliminator that removes static electricity from the surface of the image carrier by irradiating the surface with antistatic light between the transfer of the toner image and charging.

The transfer component of an intermediate-transfer apparatus may include, for example, an intermediate transfer body, the surface of which is for a toner image to be transferred to; a first transfer component, which transfers the toner image formed on the image carrier to the surface of the intermediate transfer body (first transfer); and a second transfer component, which transfers the toner image on the surface of the intermediate transfer body to the surface of a recording medium (second transfer).

Part of the image forming apparatus according to this exemplary embodiment, e.g., a portion including the developing component, may have a cartridge structure, i.e., a structure that allows the part to be detached from and attached to the image forming apparatus (or may be a process cartridge). An example of a process cartridge is one that includes a developing component that contains an electrostatic charge image developer according to the above exemplary embodiment.

The following describes an example of an image forming apparatus according to this exemplary embodiment, although this is not the only possible form. Some of its structural elements are described with reference to a drawing.

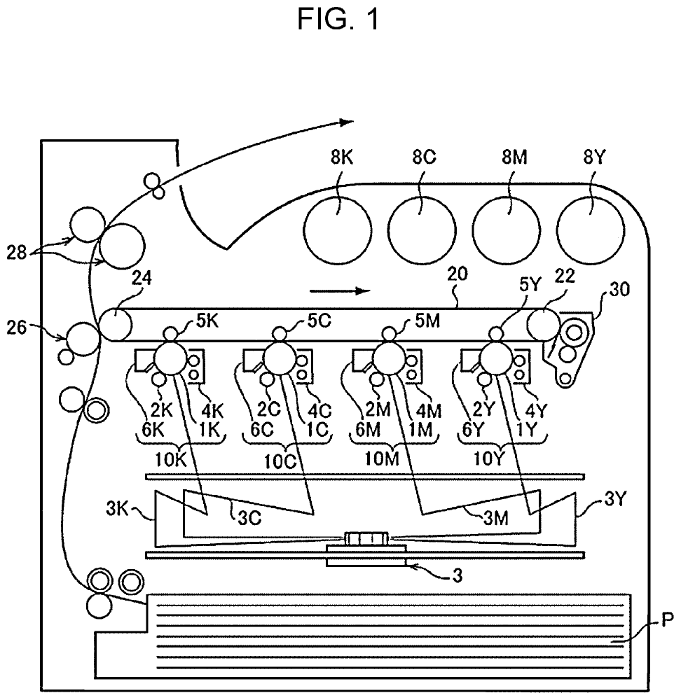

FIG. 1 is a schematic view of the structure of an image forming apparatus according to this exemplary embodiment.

The image forming apparatus illustrated in FIG. 1 includes first to fourth electrophotographic image forming units 10Y, 10M, 10C, and 10K (image forming component) that produce images in the colors of yellow (Y), magenta (M), cyan (C), and black (K), respectively, based on color-separated image data. These image forming units (hereinafter also referred to simply as “units”) 10Y, 10M, 10C, and 10K are arranged in a horizontal row with a predetermined distance therebetween. The units 10Y, 10M, 10C, and 10K may be process cartridges, i.e., units that can be detached from and attached to the image forming apparatus.

Above the units 10Y, 10M, 10C, and 10K in the drawing, an intermediate transfer belt 20 as an intermediate transfer body extends to pass through each of the units. The intermediate transfer belt 20 is wound over a drive roller 22 (right in the drawing) and a support roller 24 (left in the drawing) spaced apart from each other, with the rollers touching the inner surface of the intermediate transfer belt 20, and is driven by them to run in the direction from the first unit 10Y to the fourth unit 10K. The support roller 24 is forced by a spring or similar mechanism, not illustrated in the drawing, to go away from the drive roller 22, thereby placing tension on the intermediate transfer belt 20 wound over the two rollers. On the image-carrying side of the intermediate transfer belt 20 is a cleaning device 30 for the intermediate transfer belt 20 facing the drive roller 22.

The units 10Y, 10M, 10C, and 10K have developing devices (developing component) 4Y, 4M, 4C, and 4K, to which toners including four in the colors of yellow, magenta, cyan, and black, respectively, are delivered from toner cartridges 8Y, 8M, 8C, and 8K.

Because the first to fourth units 10Y, 10M, 10C, and 10K are equivalent in structure, the following describes the first one 10Y, located upstream of the others in the direction of running of the intermediate transfer belt 20 and forms a yellow image, on behalf of the four. The second to fourth units 10M, 10C, and 10K are not described; they have structural elements equivalent to those of the first unit 10Y, and these elements are designated with the same numerals as in the first unit 10Y but with the letters M (for magenta), C (for cyan), and K (for black), respectively, in place of Y (for yellow).

The first unit 10Y has a photoreceptor 1Y that acts as an image carrier. Around the photoreceptor 1Y are a charging roller (example of a charging component) 2Y that charges the surface of the photoreceptor 1Y to a predetermined potential; an exposure device (example of an electrostatic charge image creating component) 3 that irradiates the charged surface with a laser beam 3Y produced on the basis of a color-separated image signal to create an electrostatic charge image there; a developing device (example of a developing component) 4Y that supplies charged toner to the electrostatic charge image to develop the electrostatic charge image; a first transfer roller (example of a first transfer component) 5Y that transfers the developed toner image to the intermediate transfer belt 20; and a photoreceptor cleaning device (example of a cleaning component) 6Y that removes residual toner off the surface of the photoreceptor 1Y after the first transfer, arranged in this order.

The first transfer roller 5Y is inside the intermediate transfer belt 20 and faces the photoreceptor 1Y. Each of the first transfer rollers 5Y, 5M, 5C, and 5K is connected to a bias power supply (not illustrated) that applies a first transfer bias to the roller. Each bias power supply is controlled by a controller, not illustrated in the drawing, to change the magnitude of the transfer bias it applies to the corresponding first transfer roller.

The operation of forming a yellow image at the first unit 10Y may be as described below.

First, before the operation, the charging roller 2Y charges the surface of the photoreceptor 1Y to a potential of −600 V to −800 V.

The photoreceptor 1Y is a stack of an electrically conductive substrate (e.g., having a volume resistivity at 20° C. of 1×10⁻⁶ Ω·cm or less) and a photosensitive layer thereon. The photosensitive layer is of high electrical resistance (has the typical resistance of resin) in its normal state, but when it is irradiated with a laser beam 3Y, the resistivity of the irradiated portion changes. Thus, a laser beam 3Y is emitted using the exposure device 3 onto the charged surface of the photoreceptor 1Y in accordance with data for the yellow image sent from a controller, not illustrated in the drawing. The laser beam 3Y hits the photosensitive layer on the surface of the photoreceptor 1Y, creating an electrostatic charge image as a pattern for the yellow image on the surface of the photoreceptor 1Y.

The electrostatic charge image is an image created on the surface of the photoreceptor 1Y by electrical charging and is a so-called negative latent image, created after the charge on the surface of the photoreceptor 1Y flows away in the irradiated portion of the photosensitive layer as a result of a resistivity decrease caused by the exposure to the laser beam 3Y but stays in the portion of the photosensitive layer not irradiated with the laser beam 3Y.

As the photoreceptor 1Y rotates, the electrostatic charge image created on the photoreceptor 1Y is moved to a predetermined development point. At this development point, the electrostatic charge image on the photoreceptor 1Y is visualized (developed) as a toner image by the developing device 4Y.

Inside the developing device 4Y is an electrostatic charge image developer that contains, for example, at least yellow toner and a carrier. The yellow toner is on a developer roller (example of a developer carrier) and has been triboelectrically charged with the same polarity as the charge on the photoreceptor 1Y (negative) as a result of being stirred inside the developing device 4Y. As the surface of the photoreceptor 1Y passes through the developing device 4Y, the yellow toner electrostatically adheres to the uncharged, latent-image portion of the surface of the photoreceptor 1Y and develops the latent image. The photoreceptor 1Y, now having a yellow toner image thereon, then continues rotating at a predetermined speed, transporting the toner image developed thereon to a predetermined first transfer point.

After the arrival of the yellow toner image on the photoreceptor 1Y at the first transfer point, a first transfer bias is applied to the first transfer roller 5Y, and an electrostatic force acts on the toner image in the direction from the photoreceptor 1Y toward the first transfer roller 5Y to cause the toner image to be transferred from the photoreceptor 1Y to the intermediate transfer belt 20. The applied transfer bias has the (+) polarity, opposite the polarity of the toner (−), and its amount has been controlled by a controller (not illustrated); for example, for the first unit 10Y, it has been controlled to +10 μA.

Residual toner on the photoreceptor 1Y is removed and collected at the photoreceptor cleaning device 6Y.

The first transfer biases applied to the first transfer rollers 5M, 5C, and 5K of the second, third, and fourth units 10M, 10C, and 10K have also been controlled in the same way as that at the first unit 10Y.

The intermediate transfer belt 20 to which a yellow toner image has been transferred at the first unit 10Y in this way is then transported passing through the second to fourth units 10M, 10C, and 10K sequentially, and toner images in the respective colors are overlaid to complete multilayer transfer.

The intermediate transfer belt 20 that has passed through the first to fourth units and thereby completed multilayer transfer of toner images in four colors then reaches a second transfer section formed by the intermediate transfer belt 20, the support roller 24, which touches the inner surface of the intermediate transfer belt 20, and a second transfer roller (example of a second transfer component) 26, which is on the image-carrying side of the intermediate transfer belt 20. Recording paper (example of a recording medium) P is fed to the point of contact between the second transfer roller 26 and the intermediate transfer belt 20 in a timed manner by a feeding mechanism, and a second transfer bias is applied to the support roller 24. The applied transfer bias has the (−) polarity, the same as the polarity of the toner (−), and an electrostatic force acts on the toner image in the direction from the intermediate transfer belt 20 toward the recording paper P to cause the toner image to be transferred from the intermediate transfer belt 20 to the recording paper P. The amount of the second transfer bias has been controlled and is determined in accordance with the resistance detected by a resistance detector (not illustrated) that detects the electrical resistance of the second transfer section.

After that, the recording paper P is sent to the point of pressure contact (nip) between a pair of fixing rollers at a fixing device (example of a fixing component) 28, and the toner image is fixed on the recording paper P there to give a fixed image.

The recording paper P to which the toner image is transferred can be, for example, a piece of ordinary printing paper for copiers, printers, etc., of electrophotographic type. Recording media such as overhead-projector (OHP) sheets may also be used.

The use of recording paper P having a smooth surface may help further improve the smoothness of the surface of the fixed image; for example, coated paper, which is paper with a coating, for example of resin, on its surface, or art paper for printing may be used.

The recording paper P with a completely fixed color image thereon is transported to an ejection section to finish the formation of a color image.

### Process Cartridge/Toner Cartridge

The following describes a process cartridge according to an exemplary embodiment.

A process cartridge according to this exemplary embodiment is one attachable to and detachable from an image forming apparatus and includes a developing component that contains an electrostatic charge image developer according to the above exemplary embodiment and develops, using the electrostatic charge image developer, an electrostatic charge image created on the surface of an image carrier to form a toner image.

This is not the only possible configuration of a process cartridge according to this exemplary embodiment; the process cartridge may optionally have at least one extra component selected from an image carrier, a charging component, an electrostatic charge image creating component, a transfer component, etc., besides the developing component.

The following describes an example of a process cartridge according to this exemplary embodiment, although this is not the only possible form. The following describes some of its structural elements with reference to a drawing.

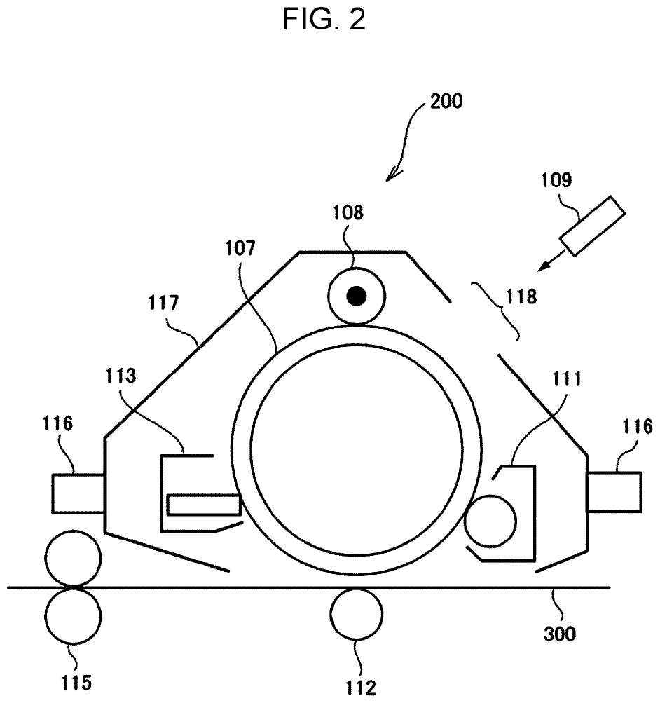

FIG. 2 is a schematic view of the structure of a process cartridge according to this exemplary embodiment. The process cartridge 200 illustrated in FIG. 2 is a cartridge containing, for example, a photoreceptor 107 (example of an image carrier) and a charging roller 108 (example of a charging component), a developing device 111 (example of a developing component), and a photoreceptor cleaning device 113 (example of a cleaning component) arranged around the photoreceptor 107, all held together in a housing 117 having attachment rails 116 and an opening 118 for exposure to light.

FIG. 2 also illustrates an exposure device (example of an electrostatic charge image creating component) 109, a transfer device (example of a transfer component) 112, a fixing device (example of a fixing component) 115, and recording paper (example of a recording medium) 300.

The following describes a toner cartridge according to this exemplary embodiment.

A toner cartridge according to this exemplary embodiment contains toner according to the above exemplary embodiment and can be attached to and detached from an image forming apparatus. A toner cartridge is a cartridge that stores replenishment toner for a developing component placed inside an image forming apparatus.

The image forming apparatus illustrated in FIG. 1 has toner cartridges 8Y, 8M, 8C, and 8K attachable to and detachable from it, and the developing devices 4Y, 4M, 4C, and 4K are connected to their corresponding toner cartridges (or the toner cartridges for their respective colors) by toner feed tubing, not illustrated in the drawing. When there is little toner in a toner cartridge, this toner cartridge is replaced.

### EXAMPLES

The following describes examples, although no aspect of the present disclosure is limited to these examples. In the following description, “parts” and “%” are all by mass unless stated otherwise.

### Production of Toner Particles (A)

### Preparation of Core Particles Dispersion (A)

Styrene (FUJIFILM Wako Pure Chemical): 80 parts
n-butyl acrylate (FUJIFILM Wako Pure Chemical): 20 parts
Divinylbenzene (FUJIFILM Wako Pure Chemical): 0.65 parts
Dodecanethiol (FUJIFILM Wako Pure Chemical): 2 parts
A cyan pigment (Pigment Blue 15:3, Dainichiseika Color & Chemicals Mfg.): 8 parts

These materials are put into a stainless steel container, premixed by stirring, and thoroughly dispersed using a medium dispersing machine (paint shaker) to give a polymerizable monomer composition.

Separately, the following ingredients are put into a round-bottom stainless steel flask and warmed to 58° C.
Deionized water: 80 parts
A 0.1 mol/L aqueous solution of Na3PO4: 100 parts
A 1 N aqueous solution of HCl: 2.8 parts

Then the contents are dispersed by stirring the mixture at a speed of rotation of 13000 rpm using a homogenizer (CLEARMIX, M Technique). Ten parts of a 1.0 mol/L aqueous solution of CaCl₂ is added little by little to give an aqueous medium containing Ca₃(PO₄)₂. While 58° C. is maintained, a dispersed polymerizable monomer composition is added to this liquid dispersion of Ca₃(PO₄)₂, and the resulting mixture is homogenized by stirring. While the contents are dispersed using the homogenizer, 6 parts of tetramethylbutyl-peroxy-2-ethyl hexanoate (NOF; trade name, PEROCTA O) is added little by little to the liquid suspension to form droplets of the polymerizable monomer composition.

The liquid suspension, now with dispersed droplets therein, is stirred inside a reflux reactor and heated to 90° C. by external heating at the same time so that polymerization will proceed. After fully reacting at the same temperature, the contents are cooled to room temperature, and deionized water is added to make the concentration of the polymerizable monomer composition in the entire liquid dispersion 20% by mass, completing core particles dispersion (A).

### Preparation of Resin Particles Dispersion (A) for Shell Layer Formation

### Making of Polyester Resin A

A 2-mole ethylene oxide adduct of bisphenol A: 49.2 parts
Ethylene glycol: 8.9 parts
Terephthalic acid: 14.4 parts
Isophthalic acid: 5.8 parts

These monomers are put into a well-dried and N₂-purged three-neck flask, dissolved by heating to 185° C. under a stream of N₂, and then mixed together thoroughly. After the addition of 0.03 parts of tetrabutoxytitanate, the system temperature is raised to 220° C., and the contents are allowed to react at this temperature for 5 hours, completing polyester resin A.

### Completion of Resin Particles Dispersion (A) for Shell Layer Formation

Polyester resin A: 100.0 parts by mass
Methyl ethyl ketone: 45.0 parts by mass
Tetrahydrofuran: 45.0 parts by mass

These materials are put into a well-dried and N₂-purged three-neck flask, dissolved by heating to 80° C. under a stream of N₂, and then mixed together thoroughly. The resulting mixture is then mixed thoroughly with 300.0 parts by mass of deionized water at 80° C., and the resulting solution is transferred to a distiller. The solution is distilled until the temperature of the distillate is 100° C., the distilled solution is cooled, and deionized water is added to adjust the concentration of polyester resin A in the entire liquid dispersion to 20% by mass. This is resin particles dispersion (A) for shell layer formation.

### Completion of Toner Particles (A)

To 500.0 parts by mass of core particles dispersion (A), 15.0 parts by mass of resin particles dispersion (A) for shell layer formation is added dropwise at a rate of 1.0 part by mass/min. The resulting solution mixture is stirred for 20 minutes at 200 rpm (rotations per minute). The solution mixture is then heated to 55° C., and dilute hydrochloric acid is added to eliminate Ca₃(PO₄)₂ by dissolution. After 2 more hours of stirring at 55° C., the solution mixture is heated to 65° C. and stirred for 1 hour. The solution mixture is then cooled to room temperature, washed thoroughly with deionized water, and separated into solid and liquid fractions by Nutsche filtration. Then the solid is dispersed again in deionized water at 40° C. and washed for 15 minutes by stirring. After several times of this washing operation, the dispersion is separated into solid and liquid fractions by Nutsche filtration, and the solid is lyophilized in a vacuum, completing toner particles (A) (volume-average diameter (D50v), 6.6 μm; average circularity Cc, 0.98).

### Production of Monodisperse Silica Particles

### Preparation of Silica Particles Dispersion (1)

In a glass reactor equipped with a stirrer, a dropping nozzle, and a thermometer, 300 parts of methanol and 70 parts of 10% aqueous ammonia are mixed to give an alkali catalyst solution. After being conditioned to 30° C. (initial temperature for addition), this alkali catalyst solution is added dropwise, while being stirred, together with 185 parts of tetramethoxysilane and 50 parts of 8% aqueous ammonia to give a hydrophilic liquid dispersion of silica particles (solids content, 12%). The duration of addition is 30 minutes. The resulting silica particles dispersion is then concentrated to a solids content of 40% with R-Fine rotary filter (Kotobuki Industries). The concentrate is silica particles dispersion (1).

### Preparation of Silica Particles Dispersions (2) to (12)

Silica particles dispersions (2) to (12) are produced in the same way as silica particles dispersion (1), except that the production of silica particles dispersion (1) is modified by changing alkali catalyst solution parameters (the amount of methanol and the concentration and amount of aqueous ammonium) and conditions for the formation of silica particles (the amount of tetramethoxysilane (TMOS) added to the alkali catalyst solution, the concentration and total loading of aqueous ammonia, and the duration of and initial temperature for addition of TMOS and aqueous ammonia) according to Table 1.

TABLE 1

| | | | | | Conditions for the formation of silica particles | | | | |
|---|---|---|---|---|---|---|---|---|---|
| | | Alkali catalyst solution | | | TMOS | Aqueous ammonia | | Duration | Initial |
| | Silica | | Aqueous ammonia | | total | | Total | of | temperature |
| Silica | particles | Methanol | Concentration | Amount | loading | Concentration | loading | addition | for addition |
| particles | dispersion | (parts) | (%) | (parts) | (parts) | (%) | (parts) | (min) | (° C.) |
| S1 | 1 | 320 | 10 | 72 | 45 | 8 | 9 | 10 | 34 |
| S2 | 2 | 340 | 10 | 76 | 45 | 8 | 15 | 13 | 31 |
| S3 | 3 | 270 | 10 | 55 | 45 | 8 | 9 | 10 | 36 |
| S4 | 4 | 340 | 10 | 76 | 45 | 8 | 15 | 14 | 31 |
| S5 | 5 | 310 | 10 | 70 | 45 | 8 | 10 | 10 | 37 |
| S6 | 6 | 320 | 10 | 72 | 45 | 8 | 9 | 10 | 37 |
| S7 | 7 | 320 | 10 | 72 | 45 | 8 | 9 | 12 | 33 |
| S8 | 8 | 320 | 10 | 72 | 45 | 8 | 9 | 11 | 34 |
| S9 | 9 | 270 | 10 | 55 | 45 | 8 | 9 | 10 | 34 |
| S10 | 10 | 280 | 10 | 60 | 45 | 8 | 9 | 10 | 34 |
| S11 | 11 | 330 | 10 | 74 | 45 | 8 | 9 | 10 | 34 |
| S12 | 12 | 340 | 10 | 76 | 45 | 8 | 9 | 10 | 34 |

### Completion of Monodisperse Silica Particles (S1)

Using silica particles dispersion (1), the surface of the silica particles is treated with a siloxane compound in a supercritical carbon dioxide atmosphere as detailed below. The system for the surface treatment is equipped with a carbon dioxide cylinder, carbon dioxide pump, entrainer pump, autoclave with a stirrer (capacity, 500 ml), and pressure valve.

First, 300 parts of silica particles dispersion (1) is put into the autoclave with a stirrer (capacity, 500 ml), and the stirrer is rotated at 100 rpm. Then liquefied carbon dioxide is injected into the autoclave, and the temperature is raised with the heater while the pressure is increased with the carbon dioxide pump to make the inside of the autoclave supercritical conditions of 150° C. and 15 MPa. With the inside of the autoclave kept at 15 MPa using the pressure valve, supercritical carbon dioxide is delivered from the carbon dioxide pump to remove methanol and water from silica particles dispersion (1) (solvent removal), giving (untreated) silica particles.

Then, when the amount of supercritical carbon dioxide delivered is 900 parts (cumulative amount measured as carbon dioxide in its standard state), the delivery of supercritical carbon dioxide is stopped.

After that, with the temperature kept at 150° C. using the heater and the pressure at 15 MPa using the carbon dioxide pump so that the carbon dioxide inside the autoclave will remain in its supercritical state, a treatment solution prepared beforehand, a solution of 0.3 parts of a 10000-cSt dimethyl silicone oil (DSO; trade name, “KF-96” (Shin-Etsu Chemical)) as a siloxane compound in 20 parts of hexamethyldisilazane (HDMS, Yuki Gosei Kogyo) as a hydrophobizing agent per 100 parts of the (untreated) silica particles, is injected into the autoclave using the entrainer pump, and the contents are allowed to react together for 20 minutes at 180° C. while being stirred. Then supercritical carbon dioxide is delivered once again to eliminate an excess of treatment solution. Then stirring is stopped, the pressure valve is opened to release the pressure inside the autoclave to atmospheric pressure, and the temperature is reduced to room temperature (25° C.)

In this way, solvent removal and surface treatment with HMDS and DSO are performed sequentially to complete monodisperse silica particles (S1).

### Production of Monodisperse Silica Particles (S2) to (S12)

Monodisperse silica particles (S2) to (S12) are produced in the same way as monodisperse silica particles (S1).

### Production of Titanate Particles (T1)

As a titanium source, 0.7 moles on a TiO₂ basis of a desulfurized and peptized metatitanate is put into a reactor. Then, as an extra metal oxide source, 0.77 moles of strontium chloride dissolved in water is added to the reactor so that the SrO/TiO₂ ratio by the number of moles will be 1.1. After that, as a dopant source, a solution of lanthanum oxide in nitric acid is added to the reactor, with the amount of the solution being such that the dopant lanthanum will constitute 1 mole per 100 moles of strontium. The initial TiO₂ concentration in the liquid mixture of the three materials is 0.75 moles/L. Then the liquid mixture is stirred, warmed to 90° C., 153 mL of a 10 N (mol/L) aqueous solution of sodium hydroxide is added over 2 hours while the mixture continues to be stirred at 90° C., and the resulting mixture is further stirred for 1 hour while its temperature is maintained at 90° C. Then the reaction solution is cooled to 40° C. and stirred for 1 hour with hydrochloric acid added to a pH of 5.5. Then the precipitate is washed by repeated decantation and dispersion in water. The pH of the slurry containing the washed precipitate is adjusted to 6.5 by adding hydrochloric acid, and the solid is collected by filtration and dried. The dried solid is stirred with a solution of isobutyltrimethoxysilane (i-BTMS) in ethanol for 1 hour, with the amount of the solution being such that i-BTMS will constitute 20 parts per 100 parts of the solid. The solid is filtered out and dried for 7 hours in air at 130° C. to complete titanate particles (T1).

### Production of Titanate Particles (T2) to (T15)

Titanate particles are obtained in the same way, except that the production of titanate particles (T1) is modified by changing the species and amount of the extra metal oxide source, the species and amount of the dopant, and the duration of addition of the 153 mL of a 10 N (mol/L) aqueous solution of sodium hydroxide according to Table 2.

It should be noted that the amount of the extra metal oxide source is adjusted so that the relative number of moles of the extra metal oxide source to that of TiO₂ will be as in Table 2.

The amount of the dopant source, on the other hand, is adjusted so that the number of moles of the dopant element per 100 moles of strontium will be as in Table 2.

TABLE 2

| | Extra metal oxide source | | Dopant source | | Duration | |
|---|---|---|---|---|---|---|
| | | Amount | | Amount | of | |
| | | (moles | | (moles | addition | |
| | | of the extra | | of the | of an | |
| | | metal oxide | | dopant/ | aqueous | |
| | | source/ | | 100 | solution of | |
| Titanate | | moles of | | moles of | sodium | |
| particles | Species | TiO₂) | Species | strontium) | hydroxide | |
| T1 | Strontium | 1.1 | Lanthanum | 1 | 2 | hours |
| | chloride | | oxide | | | |
| T2 | Strontium | 1.1 | Lanthanum | 1 | 5 | hours |
| | chloride | | oxide | | | |
| T3 | Strontium | 1.1 | Lanthanum | 1 | 1 | hours |
| | chloride | | oxide | | | |
| T4 | Strontium | 1.1 | Lanthanum | 2 | 8 | hours |
| | chloride | | oxide | | | |
| T5 | Strontium | 1.1 | Lanthanum | 2 | 55 | minutes |
| | chloride | | oxide | | | |
| T6 | Strontium | 1.1 | Lanthanum | 1 | 50 | minutes |
| | chloride | | oxide | | | |
| T7 | Strontium | 1.1 | Lanthanum | 0.2 | 2 | hours |
| | chloride | | oxide | | | |
| T8 | Strontium | 1.1 | Lanthanum | 0.3 | 2 | hours |
| | chloride | | oxide | | | |
| T9 | Strontium | 1.1 | Lanthanum | 2.7 | 2 | hours |
| | chloride | | oxide | | | |
| T10 | Strontium | 1.1 | Lanthanum | 3 | 2 | hours |
| | chloride | | oxide | | | |
| T11 | Calcium | 1.1 | Lanthanum | 1 | 2 | hours |
| | chloride | | oxide | | | |
| T12 | Barium | 1.1 | Lanthanum | 1 | 2 | hours |
| | chloride | | oxide | | | |
| T13 | Potassium | 1.1 | — | — | 2 | hours |
| | chloride | | | | | |
| T14 | Strontium | 1.1 | — | — | 2 | hours |
| | chloride | | | | | |
| T15 | Strontium | 1.1 | Silicon | 0.5 | 2 | hours |
| | chloride | | dioxide | | | |

### Example 1: Production of Toner and a Developer

To 100 parts of toner particles (A) are added 0.4 parts of surface-treated monodisperse silica particles (S1) and 0.5 parts titanate particles (T1) as external additives, and the particles are mixed together for 15 minutes by stirring with a Henschel mixer at a circumferential velocity of 30 m/sec, giving toner.

Then the resulting toner and the resin-coated carrier below are put into a V-blender in a ratio of 8:92 (toner:carrier; by mass) and stirred for 20 minutes, giving a developer.

### Carrier

Mn—Mg—Sr ferrite particles (average diameter, 40 μm): 100 parts
Toluene: 14 parts
Polymethyl methacrylate: 2 parts
Carbon black (VXC72, Cabot): 0.12 parts

The materials excluding the ferrite particles and glass beads (diameter, 1 mm; as much as toluene) are mixed together, and the mixture is stirred for 30 minutes at a speed of rotation of 1200 rpm in Kansai Paint's sand mill to give a liquid dispersion. This liquid dispersion and the ferrite particles are put into a vacuum-degassing kneader and dried by vacuuming while being stirred, yielding a resin-coated carrier.

### Examples 2 to 25 and Comparative Examples 1 to 4

Toner and a developer are obtained in the same way as in Example 1, except that toner production is modified by changing the type of toner particles and the type and amount of the external additives (surface-treated monodisperse silica particles and titanate particles) according to Tables 3-1 and 3-2.

### Testing

For each example or comparative example, the developer is loaded into the developing device of a modified version of “ApeosPort-IV C5575” image forming apparatus (Fuji Xerox; modified by disabling the sensor for automatic density control under environmental changes). Using this modified image forming apparatus, the developer is tested for fogging and stability in image density.

### Fogging

An image with an area coverage of 40% is printed repeatedly on 300,000 sheets of A4-sized paper under hot and humid conditions (28° C. and 85% RH), and the image on the last 30 sheets is inspected for fogging.

### Fogging Grades and Criteria

G1: On none of the 30 sheets does the image have fogging.

G2: The image on one sheet has a minor fogging that is acceptable in practical use.

G3: The image on multiple sheets has a minor fogging that is acceptable in practical use.

G4: The image on multiple sheets has a noticeable fogging that makes the image unsuitable for practical use.

G5: On all 30 sheets the entire image has fogging.

### Stability in Image Density

An image with an area coverage of 1% is printed repeatedly on 100,000 sheets of A4-sized paper under hot and humid conditions (28° C. and 85% RH), and the difference between the density of the image on the 100th sheet and that on the 100,000th is determined. The image density measurement is performed using an X-Rite color reflection densitometer.

### Stability in Image Density Grades and Criteria

G1: The difference between the image density on the 100,000th sheet and that on the 100th is less than 0.03

G2: The difference between the image density on the 100,000th sheet and that on the 100th is 0.03 or more and less than 0.05

G3: The difference between the image density on the 100,000th sheet and that on the 100th is 0.05 or more and less than 0.07

G4: The difference between the image density on the 100,000th sheet and that on the 100th is 0.07 or more and less than 0.09

G5: The difference between the image density on the 100,000th sheet and that on the 100th is 0.09 or more

TABLE 3-1

| | | | | Monodisperse silica particles | | | | | Titanate particles | | | | | | |
|---|---|---|---|---|---|---|---|---|---|---|---|---|---|---|---|
| | | | | | | Average | | | | | | | Average | | |
| | Toner particles | | | | | diam- | | | | | | | diam- | | |
| | | Aver- | | | | eter | Aver- | | | | | | eter | Aver- | |
| | | age | | | | of | age | Rel- | | | | | of | age | Rel- |
| | | circu- | Diam- | | | primary | circu- | ative | | | | | primary | circu- | ative |
| | | larity | eter | | Amount | particles | larity | density | | | Amount | Dopant | particles | larity | density |
| | Type | Cc | D50v | Type | (parts) | (nm) | Ca | Da | Type | | (parts) | species | (nm) | Cb | Db |
| Example | A | 0.98 | 6.6 | S1 | 0.4 | 45 | 0.90 | 1.2 | T1 | Strontium | 0.5 | Lanthanum | 45 | 0.86 | 4.6 |
| 1 | | | | | | | | | | titanate | | | | | |
| Example | A | 0.98 | 6.6 | S1 | 0.4 | 45 | 0.90 | 1.2 | T2 | Strontium | 0.5 | Lanthanum | 60 | 0.86 | 4.6 |
| 2 | | | | | | | | | | titanate | | | | | |
| Example | A | 0.98 | 6.6 | S2 | 0.4 | 70 | 0.94 | 1.2 | T1 | Strontium | 0.5 | Lanthanum | 45 | 0.86 | 4.6 |
| 3 | | | | | | | | | | titanate | | | | | |
| Example | A | 0.98 | 6.6 | S3 | 0.4 | 25 | 0.86 | 1.2 | T1 | Strontium | 0.5 | Lanthanum | 45 | 0.86 | 4.6 |
| 4 | | | | | | | | | | titanate | | | | | |
| Example | A | 0.98 | 6.6 | S2 | 0.4 | 70 | 0.94 | 1.2 | T2 | Strontium | 0.5 | Lanthanum | 60 | 0.86 | 4.6 |
| 5 | | | | | | | | | | titanate | | | | | |
| Com- | A | 0.98 | 6.6 | S2 | 0.4 | 70 | 0.94 | 1.2 | T3 | Strontium | 0.5 | Lanthanum | 25 | 0.86 | 4.6 |
| parative | | | | | | | | | | titanate | | | | | |
| Example | | | | | | | | | | | | | | | |
| 1 | | | | | | | | | | | | | | | |
| Com- | A | 0.98 | 6.6 | S4 | 0.4 | 75 | 0.94 | 1.2 | T4 | Strontium | 0.5 | Lanthanum | 75 | 0.90 | 4.6 |
| parative | | | | | | | | | | titanate | | | | | |
| Example | | | | | | | | | | | | | | | |
| 2 | | | | | | | | | | | | | | | |
| Example | A | 0.98 | 6.6 | S5 | 0.4 | 20 | 0.86 | 1.2 | T5 | Strontium | 0.5 | Lanthanum | 20 | 0.90 | 4.6 |
| 6 | | | | | | | | | | titanate | | | | | |
| Com- | A | 0.98 | 6.6 | S6 | 0.4 | 19 | 0.9 | 1.2 | T3 | Strontium | 0.5 | Lanthanum | 25 | 0.86 | 4.6 |
| parative | | | | | | | | | | titanate | | | | | |
| Example | | | | | | | | | | | | | | | |
| 3 | | | | | | | | | | | | | | | |
| Com- | A | 0.98 | 6.6 | S1 | 0.4 | 45 | 0.9 | 1.2 | T6 | Strontium | 0.5 | Lanthanum | 19 | 0.86 | 4.6 |
| parative | | | | | | | | | | titanate | | | | | |
| Example | | | | | | | | | | | | | | | |
| 4 | | | | | | | | | | | | | | | |
| Example | A | 0.98 | 6.6 | S7 | 0.4 | 55 | 0.9 | 1.2 | T1 | Strontium | 0.5 | Lanthanum | 45 | 0.86 | 4.6 |
| 7 | | | | | | | | | | titanate | | | | | |
| Example | A | 0.98 | 6.6 | S9 | 0.4 | 45 | 0.86 | 1.2 | T1 | Strontium | 0.5 | Lanthanum | 45 | 0.86 | 4.6 |
| 8 | | | | | | | | | | titanate | | | | | |
| Example | A | 0.98 | 6.6 | S10 | 0.4 | 45 | 0.87 | 1.2 | T1 | Strontium | 0.5 | Lanthanum | 45 | 0.86 | 4.6 |
| 9 | | | | | | | | | | titanate | | | | | |
| Example | A | 0.98 | 6.6 | S11 | 0.4 | 45 | 0.93 | 1.2 | T1 | Strontium | 0.5 | Lanthanum | 45 | 0.86 | 4.6 |
| 10 | | | | | | | | | | titanate | | | | | |
| Example | A | 0.98 | 6.6 | S12 | 0.4 | 45 | 0.94 | 1.2 | T1 | Strontium | 0.5 | Lanthanum | 45 | 0.86 | 4.6 |
| 11 | | | | | | | | | | titanate | | | | | |
| Example | A | 0.98 | 6.6 | S1 | 0.4 | 45 | 0.90 | 1.2 | T7 | Strontium | 0.5 | Lanthanum | 45 | 0.78 | 4.6 |
| 12 | | | | | | | | | | titanate | | | | | |
| Example | A | 0.98 | 6.6 | S1 | 0.4 | 45 | 0.90 | 1.2 | T8 | Strontium | 0.5 | Lanthanum | 45 | 0.79 | 4.6 |
| 13 | | | | | | | | | | titanate | | | | | |
| Example | A | 0.98 | 6.6 | S1 | 0.4 | 45 | 0.90 | 1.2 | T9 | Strontium | 0.5 | Lanthanum | 45 | 0.93 | 4.6 |
| 14 | | | | | | | | | | titanate | | | | | |
| Example | A | 0.98 | 6.6 | S1 | 0.4 | 45 | 0.90 | 1.2 | T10 | Strontium | 0.5 | Lanthanum | 45 | 0.94 | 4.6 |
| 15 | | | | | | | | | | titanate | | | | | |
| Example | A | 0.98 | 6.6 | S3 | 0.4 | 25 | 0.86 | 1.2 | T5 | Strontium | 0.5 | Lanthanum | 20 | 0.90 | 4.6 |
| 16 | | | | | | | | | | titanate | | | | | |
| Example | A | 0.98 | 6.6 | S1 | 0.4 | 45 | 0.9 | 1.2 | T11 | Calcium | 0.5 | Lanthanum | 45 | 0.87 | 4.0 |
| 17 | | | | | | | | | | titanate | | | | | |
| Example | A | 0.98 | 6.6 | S1 | 0.4 | 45 | 0.9 | 1.2 | T12 | Barium | 0.5 | Lanthanum | 45 | 0.87 | 6 |
| 18 | | | | | | | | | | titanate | | | | | |
| Example | A | 0.98 | 6.6 | S1 | 0.4 | 45 | 0.9 | 1.2 | T13 | Potassium | 0.5 | None | 45 | 0.77 | 3.3 |
| 19 | | | | | | | | | | titanate | | | | | |
| Example | A | 0.98 | 6.6 | S1 | 0.4 | 45 | 0.9 | 1.2 | T14 | Strontium | 0.5 | None | 45 | 0.76 | 4.6 |
| 20 | | | | | | | | | | titanate | | | | | |
| Example | A | 0.98 | 6.6 | S1 | 0.4 | 45 | 0.9 | 1.2 | T15 | Strontium | 0.5 | Silica | 45 | 0.86 | 4.6 |
| 21 | | | | | | | | | | titanate | | | | | |
| Example | A | 0.98 | 6.6 | S1 | 5.5 | 45 | 0.90 | 1.2 | T1 | Strontium | 0.5 | Lanthanum | 45 | 0.86 | 4.6 |
| 22 | | | | | | | | | | titanate | | | | | |
| Example | A | 0.98 | 6.6 | S1 | 5 | 45 | 0.90 | 1.2 | T1 | Strontium | 0.5 | Lanthanum | 45 | 0.86 | 4.6 |
| 23 | | | | | | | | | | titanate | | | | | |
| Example | A | 0.98 | 6.6 | S1 | 0.05 | 45 | 0.90 | 1.2 | T1 | Strontium | 0.5 | Lanthanum | 45 | 0.86 | 4.6 |
| 24 | | | | | | | | | | titanate | | | | | |
| Example | A | 0.98 | 6.6 | S1 | 0.045 | 45 | 0.90 | 1.2 | T1 | Strontium | 0.5 | Lanthanum | 45 | 0.86 | 4.6 |
| 25 | | | | | | | | | | titanate | | | | | |

TABLE 3-2

| | Difference in | Diameter | Relative | | Testing | |
|---|---|---|---|---|---|---|
| | diameter (Si | ratio (Ti | quantity (Ti | | | Stability |
| | particles-Ti | particles/Si | particles/Si | Circularity | | in image |
| | particles, nm) | particles) | particles) | ratio (Cb/Cc) | Fogging | density |
| Example 1 | 0 | 1.0 | 1.25 | 0.877551 | G1 | G1 |
| Example 2 | 15 | 1.3 | 1.25 | 0.877551 | G2 | G1 |
| Example 3 | 25 | 0.6 | 1.25 | 0.877551 | G2 | G1 |
| Example 4 | 20 | 1.8 | 1.25 | 0.877551 | G3 | G3 |
| Example 5 | 10 | 0.9 | 1.25 | 0.877551 | G3 | G2 |
| Comparative | 45 | 0.4 | 1.25 | 0.877551 | G4 | G4 |
| Example 1 | | | | | | |
| Comparative | 0 | 1.0 | 1.25 | 0.9183673 | G4 | G4 |
| Example 2 | | | | | | |
| Example 6 | 0 | 1.0 | 1.25 | 0.9183673 | G3 | G3 |
| Comparative | 6 | 1.3 | 1.25 | 0.877551 | G5 | G5 |
| Example 3 | | | | | | |
| Comparative | 26 | 0.4 | 1.25 | 0.877551 | G4 | G5 |
| Example 4 | | | | | | |
| Example 7 | 10 | 0.8 | 1.25 | 0.877551 | G1 | G1 |
| Example 8 | 0 | 1.0 | 1.25 | 0.877551 | G2 | G1 |
| Example 9 | 0 | 1.0 | 1.25 | 0.877551 | G1 | G1 |
| Example 10 | 0 | 1.0 | 1.25 | 0.877551 | G1 | G1 |
| Example 11 | 0 | 1.0 | 1.25 | 0.877551 | G1 | G2 |
| Example 12 | 0 | 1.0 | 1.25 | 0.7959184 | G1 | G2 |
| Example 13 | 0 | 1.0 | 1.25 | 0.8061224 | G2 | G3 |
| Example 14 | 0 | 1.0 | 1.25 | 0.9489796 | G2 | G2 |
| Example 15 | 0 | 1.0 | 1.25 | 0.9591837 | G3 | G3 |
| Example 16 | 5 | 0.8 | 1.25 | 0.9183673 | G3 | G3 |
| Example 17 | 0 | 1.0 | 1.25 | 0.8877551 | G3 | G3 |
| Example 18 | 0 | 1.0 | 1.25 | 0.8877551 | G3 | G3 |
| Example 19 | 0 | 1.0 | 1.25 | 0.7857143 | G3 | G3 |
| Example 20 | 0 | 1.0 | 1.25 | 0.7755102 | G2 | G2 |
| Example 21 | 0 | 1.0 | 1.25 | 0.877551 | G1 | G1 |
| Example 22 | 0 | 1.0 | 0.09 | 0.877551 | G3 | G3 |
| Example 23 | 0 | 1.0 | 0.1 | 0.877551 | G3 | G2 |
| Example 24 | 0 | 1.0 | 10 | 0.877551 | G2 | G3 |
| Example 25 | 0 | 1.0 | 11 | 0.877551 | G3 | G3 |

The meaning of the terms in the table is as follows.
Difference in diameter (Si particles−Ti particles, nm): Absolute difference between the average diameter of primary particles of the monodisperse silica particles and that of the titanate particles
Diameter ratio (Ti particles/Si particles): Ratio of the average diameter of primary particles of the titanate particles to that of the monodisperse silica particles
Relative quantity (Ti particles/Si particles): Relative quantity of the titanate particles to that of the monodisperse silica particles
Circularity ratio (Cb/Cc): Ratio of the average circularity Cb of the titanate particles to the average circularity Cc of the toner particles (Cb/Cc)

As can be seen from the results, the toners of the Examples may help reduce the event of the fixation of toner adhering to non-image areas (fogging) in repeated image formation under hot and humid conditions.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A toner for developing an electrostatic charge image, the toner comprising:
toner particles having an average circularity Cc of 0.98 or more; and
external additives including monodisperse silica particles having an average diameter of primary particles of 20 nm or more and 70 nm or less and titanate particles having an average diameter of primary particles of 20 nm or more and 70 nm or less, wherein:
an absolute difference between the average diameter of primary particles of the monodisperse silica particles and the average diameter of primary particles of the titanate particles is 25 nm or less.

2. The toner according to claim 1 for developing an electrostatic charge image, wherein:
the monodisperse silica particles have an average circularity Ca of more than 0.86 and less than 0.94; and
the titanate particles have an average circularity Cb of more than 0.78 and less than 0.94.

3. The toner according to claim 2 for developing an electrostatic charge image, wherein the average circularity Ca of the monodisperse silica particles is larger than the average circularity Cb of the titanate particles.

4. The toner according to claim 1 for developing an electrostatic charge image, wherein:
the monodisperse silica particles have a relative density Da of 1.1 or more and 1.3 or less; and
the titanate particles have a relative density db larger than the relative density Da of the monodisperse silica particles.

5. The toner according to claim 4 for developing an electrostatic charge image, wherein the relative density db of the titanate particles is 4.0 or more and 6.5 or less.

6. The toner according to claim 1 for developing an electrostatic charge image, wherein the titanate particles are particles of an alkaline earth metal titanate.

7. The toner according to claim 1 for developing an electrostatic charge image, wherein the titanate particles contain at least one dopant.

8. The toner according to claim 7 for developing an electrostatic charge image, wherein the dopant is at least one of lanthanum or silica.

9. The toner according to claim 1 for developing an electrostatic charge image, wherein a relative quantity of the titanate particles to a quantity of the monodisperse silica particles expressed as a ratio by mass is 0.1 or more and 10 or less.

10. An electrostatic charge image developer comprising the toner according to claim 1 for developing an electrostatic charge image.

11. A toner cartridge attachable to and detachable from an image forming apparatus, the toner cartridge comprising the toner according to claim 1 for developing an electrostatic charge image.
